(19) United States
(12) Patent Application Publication
(10) Pub. No.: US 2014/0251543 A1
(43) Pub. Date: Sep. 11, 2014

(54) DEVICE FOR ASSEMBLING LENS ELEMENT ON SUBSTRATE

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 14/062,870

(22) Filed: Oct. 24, 2013

(30) Foreign Application Priority Data
Mar. 7, 2013 (TW) 102108141

(51) Int. Cl. G02B 7/02

(52) U.S. Cl. CPC G02B 7/02
USPC 156/350

(57) ABSTRACT

A device for precisely assembling a lens element on a substrate includes a vacuum nozzle for lifting and carrying the lens element and a driver for moving and positioning the nozzle to position the lens element onto the substrate. The substrate supports a light receiver. The lens element includes a first lens facing the light receiver and a second lens optically coupled with the first lens. The device also includes a light emitter arranged on the driver and aligned with the second lens when the lens element is being held in place by the vacuum nozzle. The driver adjusts the placement of the lens element on the substrate until the intensity of incident light recorded by the light receiver reaches a maximum value.

### BACKGROUND

1. Technical Field

The present disclosure relates to optical connectors and, particularly to a device for assembling a lens element on a substrate.

2. Description of Related Art

Optical connectors include a substrate, a light receiver, and a lens element. The light receiver and the lens element are positioned on the substrate. The light receiver receives light. The lens element covers the light receiver and includes a first lens aligning with the light receiver and a second lens optically coupled with the first lens and configured to direct the light from the light receiver via the first lens. To reduce loss of light, alignment between the light receiver and the first lens must be precise. However, current assembly precision of the lens element onto the substrate does not often satisfy the requirement.

Therefore, it is desirable to provide a device for assembling a lens element on a substrate which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a schematic view of a device for assembling a lens element onto a substrate, according to an embodiment.

FIG. 2 is a partial view of the device of FIG. 1.

### DETAILED DESCRIPTION

Embodiments of the present disclosure will be described with reference to the drawings.

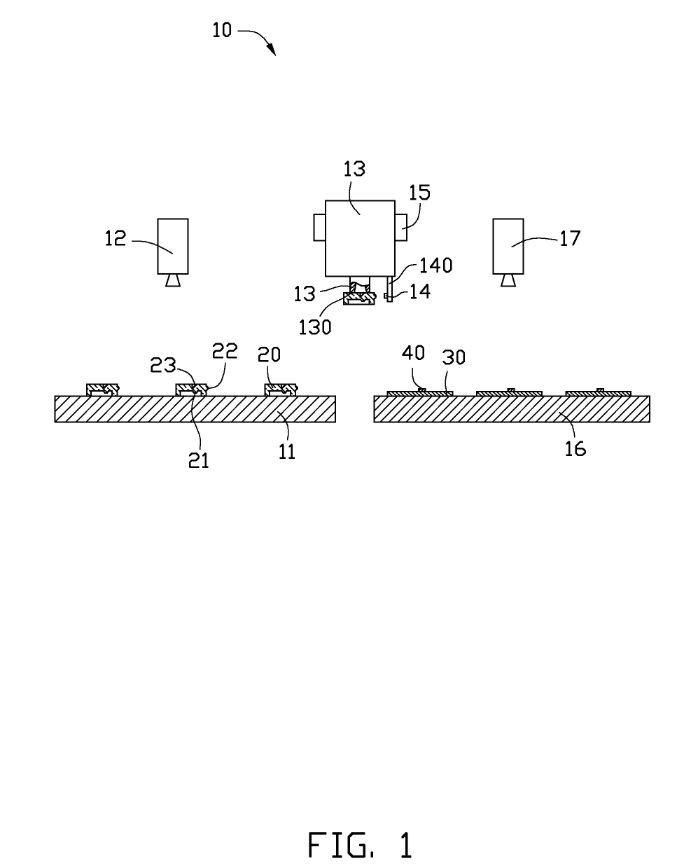

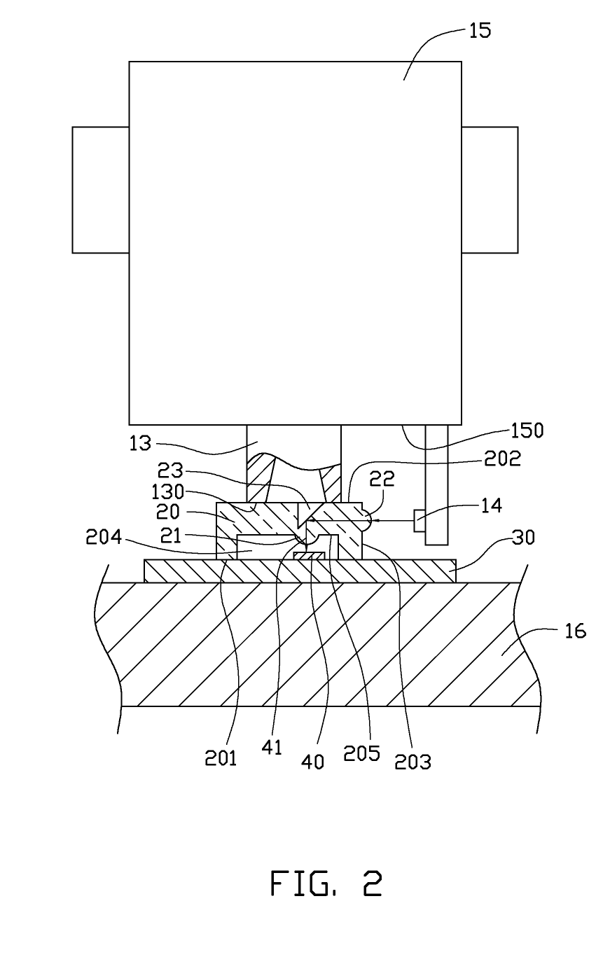

FIGS. 1 and 2 show a device 10 according to an embodiment. The device 10 is configured for assembling a lens element 20 onto a substrate 30.

The substrate 30, such as a rigid printed circuit board, supports and is electrically connected with a light receiver 40, such as a photo diode, and drives the light receiver 40 to receive a laser beam 41. The light receiver 40 measures the intensity of light incident thereon.

The lens element 20 is substantially rectangular and includes a bonding surface 201, a landing surface 202 opposite to the bonding surface 201, and a receiving surface 203 perpendicularly connecting the bonding surface 201 and the landing surface 202. The lens element 20 defines a substantially rectangular recess 204 in the bonding surface 201. The lens element 20 includes a first lens 21 bulging from a bottom surface 205 of the recess 204, and a second lens 22 bulging from the receiving surface 203. The lens element 20 also defines a triangular groove 23 in the landing surface 202. The lens element 20 provides a reflective optical coupling between the first lens 21 and the second lens 22. As such, if the light receiver 40 is optically aligned with the first lens 21, the light beam 41 will be precisely directed to the light receiver 40 via the first lens 21.

The device 10 includes a first tray 11, a first camera module 12, a nozzle 13, a light emitter 14, a driver 15, a second tray 16, and a second camera module 17.

The first tray 11 supports the lens element 20. To increase efficiency, the first tray 11 can be configured to support a number of the lens elements 20, which can be arrayed.

The first camera module 12 is positioned above the first tray 11 and takes images of the lens element 20 on the first tray 11. The first camera module 12 also processes the images of the lens element 20 to recognize a shape and position of the lens element 20.

The nozzle 13 can lift flat objects using a vacuum and suction lifts the lens element 20. In detail, the nozzle 13 includes a holding surface 130 onto which the lens element 20 is suction lifted. A hole (not shown) is defined in the holding surface 130 and extends to a vacuum pump (not shown) to enable the evacuation of air. To avoid the lens element 20 being damaged by the nozzle 13 when vacuum-lifted, a buffer layer (not shown) is attached to the holding surface 130.

The light emitter 14 includes a holding rod 140. The light emitter 14 is configured to emit the laser beam 41. The light emitter 14 can be a light-emitting diode (LED), or a laser diode (LD). In the embodiment, the light emitter 14 is an LED.

The driver 15, such as a mechanical arm, includes a connecting surface 150. The nozzle 13 and the holding rod 140 both extend from the connecting surface 150 along substantially the same direction. The holding surface 130 faces away from the driver 15. A sum of a height of the nozzle 13 and a distance from the optical axis of the second lens 22 to the landing surface 202 is substantially equal to a distance from the optical axis of the light emitter 14 to the connecting surface 150. As such, when the lens element 20 is suction lifted by the nozzle 13, the optical axis of the light emitter 14 is substantially aligned with the optical axis of the second lens 22.

The driver 15 is in communication with the first camera module 12. The driver 15 drives the nozzle 13 under supervision of the first camera module 12 to accurately position the holding surface 130 on the lens element 20.

The second tray 16 supports the substrate 30. To increase efficiency, the second tray 16 can be configured to support a number of the substrates 30, which can be placed in an array.

The second camera module 17 is positioned above the second tray 16 and takes images of the substrate 30 on the second tray 16. The second camera module 17 also processes the images of the substrate 30 to recognize a shape and position of the substrate 30.

The driver 15 is in communication with the second camera module 17 and drives the nozzle 13 under supervision of the second camera module 17 to position the lens element 20 on the substrate 30. During this process, a position of the lens element 20 on the substrate 30 can be adjusted by the driver 15 according to the intensity of light as measured by the light receiver 40, to accurately align the first lens 21 with the light receiver 40. In particular, when the first lens 21 is aligned with the light receiver 40, the light power measured by the light receiver 40 reaches a maximum value. As such, the driver 15 can adjust the position of the lens element 20 until the light power as measured by the light receiver 40 reaches a maximum value.

The first camera module 12 and the second camera module 17 can be charge-coupled devices (CCD) or complementary metal-oxide semiconductor (CMOS) devices.

Under supervision of the first camera module 12 and the second camera module 17 and the monitoring of the light emitter 14, assembly precision of the lens element 20 onto the substrate 30 is enhanced.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A device, comprising:
a nozzle configured for vacuum-lifting a lens element, the lens element comprising a landing surface suction-lifted by the nozzle, a bonding surface opposite to the landing surface, and an receiving surface substantially perpendicularly connecting the bonding surface and the landing surface, the lens element defining a substantially rectangular recess in the bonding surface and comprising a first lens bulging up from a bottom surface of the recess and a second lens bulging up from the receiving surface, the lens element also defining a triangular groove in the landing surface which optically couple the first lens with the second lens;
a driver configured for driving the nozzle to position the lens element onto a substrate, the substrate supporting and electrically connected with a light receiver, the substrate being configured to drive the light receiver to receive a laser beam; and
a light emitter comprising a holding rod and configured for emitting the laser beam;
wherein the driver comprises a connecting surface, the nozzle and the holding rod both extend from the connecting surface along the substantially same direction, a sum of a height of the nozzle and a distance from an optical axis of the second lens to the holding surface is substantially equal to a distance from an optical axis of the light emitter to the connecting surface, when the lens element is suction-lifted by the nozzle, and the driver is configured to adjust a position of the lens element on the substrate until the power of the laser beam measured by the light receiver reaches a maximum value.

2. The device of claim 1, comprising:
a first tray for supporting the lens element; and
a first camera module positioned above the first tray and configured to take a plurality of images of the lens element on the first tray, the first camera module being configured to process the images to recognize a position of the lens element on the first tray and a shape of the lens element;
wherein the driver is in communication with the first camera module, the driver is configured for driving the nozzle to move under supervision of the first camera module to accurately position a holding surface of the nozzle on the lens element.

3. The device of claim 2, wherein the first tray is configured to support a plurality of the lens elements.

4. The device of claim 3, wherein the lens elements are arrayed on the first tray.

5. The device of claim 1, wherein the driver is a mechanical arm.

6. The device of claim 1, comprising:
a second tray configured for supporting the substrate; and
a second camera module positioned above the second tray and configured to take images of the substrate on the second tray, the third camera module being configured to process the images to recognize a position of the substrate on the second tray and a shape of the substrate;
wherein the driver is in communication with the second camera module and further configured for driving the nozzle to move under supervision of the second camera module to position the lens element on the substrate before the position adjustment of the lens element on the substrate.

7. The device of claim 6, wherein the second tray is configured to support a plurality of the substrates.

8. The device of claim 7, wherein the substrates are arrayed on the second tray.

9. The device of claim 1, wherein the light emitter is a light-emitting diode, or a laser diode.

10. The device of claim 1, wherein the light receiver is a photo diode.
